(19) United States
(12) Patent Application Publication
(10) Pub. No.: US 2025/0381986 A1
(43) Pub. Date: Dec. 18, 2025

(54) METHOD FOR PLANNING A TARGET TRAJECTORY FOR AN AUTOMATICALLY DRIVING VEHICLE

(71) Applicant: MERCEDES-BENZ GROUP AG, Stuttgart (DE)

(72) Inventors: Martin Ulrich KOLBE, Engen (DE); Alexander HECKMANN, Radolfzell (DE); Simon SCHÄFER, Stuttgart (DE)

(21) Appl. No.: 18/877,296

(22) PCT Filed: Apr. 24, 2023
(86) PCT No.: PCT/EP2023/060701

§ 371 Date: Dec. 20, 2024

(30) Foreign Application Priority Data
Jun. 21, 2022 (DE) 10 2022 002 253.2

(51) Int. Cl. B60W 60/00; B60W 10/04; B60W 10/18; B60W 50/00

(52) U.S. Cl. CPC B60W 60/0011; B60W 10/04; B60W 10/18; B60W 50/0098; B60W 2050/0022; B60W 2050/0052; B60W 2554/802; B60W 2710/18; B60W 2720/106

(57) ABSTRACT

A target trajectory for an automatically driving vehicle is planned using a quality value determined for each object detected in a planning horizon. The quality value specifies a measure for a degree of reliability of the detection of the object. For each object, depending on its quality value, a minimally permissible acceleration is determined with which the vehicle may be braked onto the object. Trajectory candidates and the object costs determined for these are evaluated depending on an acceleration predetermined by the respective trajectory candidate and depending on a minimally permissible acceleration when braking onto the object. A target trajectory is selected depending on trajectory costs from a number of trajectory candidates and additionally taking into consideration the evaluation of the trajectory candidates and the object costs ascertained for these.

### BACKGROUND AND SUMMARY OF THE INVENTION

Exemplary embodiments of the invention relater to a method for planning a target trajectory for an automatically driving vehicle.

A method for planning a target trajectory, which is to be followed automatically by a vehicle, is known from DE 10 2020 108 857 A1. The planning is based on a determination of a discrete number of candidates for the target trajectory and on a selection of a candidate from a certain number of candidates. The selection is based on predetermined cost functions. Upon determining a change of boundary conditions to be observed and driving tasks to be carried out, a pilot control of the selection is undertaken by the cost functions for individual trajectory sections of the candidates being adjusted to the amended boundary conditions and driving tasks, in order to allocate lower costs to trajectory sections, which are more suitable for maintaining the changed boundary conditions and for carrying out the changed driving tasks than other trajectory sections. The target trajectory comprises, as a dataset, both information about a location course which the vehicle is to follow when following the target trajectory, and further information about an acceleration and a driving speed with which the vehicle is to move when following the target trajectory. Furthermore, a number of trajectories from which the target trajectory is selected is discretized, wherein a predetermined number of temporally ordered trajectory points of support is determined in a forecast horizon and the number of trajectories running according to a temporal order through the various trajectory points of support is determined. The number of the trajectories running according to the temporal order through the trajectory points of support forms a trajectory set, which is taken into consideration as candidates upon selecting the target trajectory. Costs are determined for each trajectory of the trajectory set by means of predetermined cost functions, wherein total costs of a trajectory section determined by means of a weighted summation of the costs of a trajectory section determined for the various boundary conditions are ascertained. Costs of a trajectory are ascertained by means of summation of total costs of their trajectory sections. The trajectory which has the lowest costs is then selected from the trajectory set as the target trajectory.

A method for controlling a vehicle is known from DE 10 2020 200 183 A1, in which a probabilistic free space map with static and dynamic objects is compiled for the surroundings of the vehicle and in which a trajectory of the vehicle is planned, taking the probabilistic free space map into consideration, and is optimized by means of a cost function.

A method for determining a deviation trajectory for a vehicle for driving around an obstacle is known from DE 10 2015 016 544 A1, in which it is provided to optimize the deviation trajectory with regard to predetermined criteria, wherein the predetermined criteria comprise an upper limit of an acceleration of the vehicle, a lower limit of a distance apart from the obstacle and a transverse speed at the end of the deviation trajectory.

A method for trajectory planning is known from DE 10 2016 218 121 A1 in which a movement model of the ego vehicle, collision-relevant objects, and driving physical limitations are used for the trajectory planning. Here, several possible trajectories are each evaluated with a cost function and then the trajectory with the minimum costs is selected.

Exemplary embodiments of the invention are directed to a novel method for planning a target trajectory for an automatically driving vehicle.

In a method for planning a target trajectory for an automatically, in particular highly automatic or autonomously driving vehicle, a number of trajectory candidates is predetermined for a predetermined planning horizon, wherein each trajectory candidate predetermines a path, which the vehicle is to follow upon selecting the trajectory candidate as the target trajectory, and predetermines an acceleration with which the vehicle is to follow this path. Objects are detected within the planning horizon and in each case trajectory costs are allocated to the trajectory candidates by means of a predetermined cost function, wherein the cost function comprises object costs dependent on the detected objects. Here, the object costs of an object increase for a trajectory candidate with decreasing distance between the object and the trajectory candidate. The target trajectory is selected from the number of trajectory candidates depending on the trajectory costs.

According to the invention, a quality value is determined for each detected object, the quality value specifying a measure for a degree of reliability of the detection of the object. Depending on its quality value, a minimally permissible level of acceleration is determined for each object, with which acceleration the vehicle may be braked onto the object. The trajectory candidates and the object costs determined for these are evaluated depending on the acceleration predetermined by the respective trajectory candidate and depending on the minimally permissible level of acceleration when braking onto the object. The selection of the target trajectory is additionally carried out taking the evaluation of the trajectory candidates and the object costs ascertained for these into consideration.

The present invention makes it possible to take the quality of the detection of the objects, i.e., the existence probability, into consideration in traffic scenarios, for example also with several objects, and to correspondingly adjust a maximum braking intervention in an automatic control of the vehicle. Here, it is ensured that an object with low detection quality alone never leads to a stronger braking intervention than allowed. There remains, however, the option of braking more strongly when this is required due to an object with higher detection quality. It is also possible to drive around an object with low detection quality.

In a possible design of the method, the trajectory candidate with the lowest trajectory costs is selected as the target trajectory from the number of the trajectory candidates. Thus, the trajectory is selected as the target trajectory in which the detected objects have the lowest degree of influence on the vehicle and/or in which the lowest number of objects is present.

In a further possible design of the method, a categorization is undertaken when evaluating, wherein distinction is made in the categorization between an unfiltered and a filtered category. Here, all object costs and the corresponding trajectory candidates are allocated to the unfiltered category. This means no trajectory candidates are filtered out. Only those object costs and the corresponding trajectory candidates for which the minimum acceleration predetermined by the respective trajectory candidate is greater than a minimally permissible acceleration of the respective object are allocated to the filtered category. This makes it possible for only those trajectory candidates whose accelerations lie in the permissible range determined by the minimally permissible acceleration to be allocated to the filtered category. Thus, the trajectory candidates leading to an impermissibly great degree of braking are missing in the filtered category. By taking the categories into consideration, a reliability of the method can be further increased.

In a further possible design of the method, in each case the trajectory candidate with the lowest trajectory costs is selected when selecting the target trajectory from the unfiltered category and the filtered category. For the two selected trajectory candidates, in each case the minimum of the acceleration predetermined by the respective trajectory candidate is determined, and the candidate with the greater minimum is selected as the target trajectory. This makes it possible for the trajectory to be chosen as the target trajectory from a plurality of possible trajectories which carries out a less strong degree of braking onto an object with the same degree of safety, such that a degree of comfort for vehicle occupants is increased with the same degree of safety.

Exemplary embodiments of the invention are explained in more detail below by means of drawings.

### BRIEF DESCRIPTION OF THE DRAWING FIGURES

Here are shown:

FIG. 1, schematically, a temporal course of an acceleration of a vehicle and corresponding temporal course of a longitudinal position of the vehicle when this follows a path of a trajectory,

FIG. 2, schematically, temporal courses of an acceleration of a vehicle and corresponding temporal courses of a longitudinal position of the vehicle when this follows paths of different trajectories,

FIG. 3, schematically, a minimally permissible acceleration depending on a reliability of a detection of an object and

FIG. 4, schematically, a process of a method for determining object costs,

FIG. 5, schematically, a process of a method for selecting a target trajectory from trajectories of different categories and

FIG. 6, schematically, a top view of a traffic scenario with a vehicle and several objects.

Parts corresponding to one another are provided with the same reference numbers in all figures.

### DETAILED DESCRIPTION

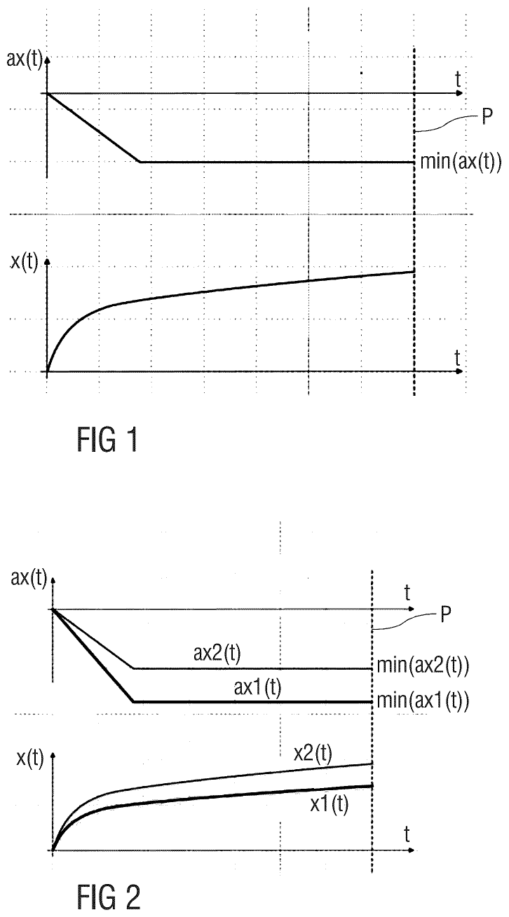

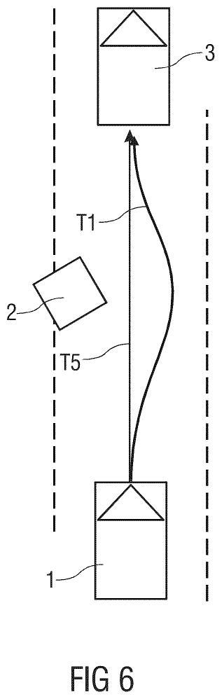

In FIG. 1, an acceleration ax(t) of an automatically, in particular highly automatically or autonomously, driving vehicle 1 depending on the time t and a corresponding temporal course of a longitudinal position x (t) of the vehicle 1 are depicted when this follows a path of a trajectory T1 to Tn shown in FIG. 6.

Each trajectory T1 to Tn is described by its longitudinal position x (t), a transverse position and its derivations, i.e., its speeds in the longitudinal direction and transverse direction, and its acceleration ax(t) in the longitudinal direction and its acceleration in the transverse direction up to a planning horizon P. Here, the longitudinal position x (t) is derived by integrating a predefined acceleration ax(t). The acceleration ax(t) is defined in such a way that the integrated longitudinal position x (t) meets the following criteria:

$$x 1 ( t ) < x 2 ( t ) \qquad ( 1 )$$

$$and$$

$$min ( ax 1 ( t ) ) < min ( ax 2 ( t ) ) f \ddot{u} r t = [ 0 , P ] . \qquad ( 2 )$$

where: x1 (t)=longitudinal position x (t) when following a trajectory T1,
x2(t)=longitudinal position x (t) when following a trajectory T2,
ax1(t)=acceleration in the longitudinal direction when following the trajectory T1,
ax2(t)=acceleration in the longitudinal direction when following the trajectory T2.

Here, a trajectory T1 to Tn next to the path which the vehicle 1 is to follow also predetermines an acceleration course with which the vehicle 1 is to follow the path. The acceleration ax(t) is here the temporal acceleration course when following the trajectory T1 to Tn. The acceleration ax(t) is negative when the vehicle 1 is braking. The acceleration ax(t) has a minimum min (ax(t)).

An example for different temporal courses of an acceleration ax1(t), ax2(t) of the vehicle 1 and corresponding temporal courses of a longitudinal position x1 (t), x2(t) of the vehicle 1 and minimums min (ax1(t)), min (ax2(t)) of the accelerations ax1(t), ax2(t) when the vehicle follows paths of different trajectories T1, T2 is depicted in FIG. 2.

In a method for planning a target trajectory for the automatically driving vehicle 1, several trajectories T1 to Tn, for example in the form of a trajectory set, are predetermined. A number of the trajectories T1 to Tn are, for example, on the order of 1,000.

Here, the following condition applies

$$x 1 ( t ) < x 2 ( t ) , wherein min ( ax 1 ( t ) ) < min ( ax 2 ( t ) ) . \qquad ( 3 )$$

This condition means that the trajectories T1 to Tn of the trajectory set are determined in such a way that it applies for any two trajectories T1, T2 that x1 (t)<x2(t) when min (ax1(t))<min (ax2(t)). This is a boundary condition which is applied when predetermining the trajectories T1 to Tn.

This means, for planning the target trajectory, a number of trajectory candidates is predetermined for a predetermined planning horizon P, wherein each trajectory candidate predetermines a path which the vehicle 1 is to follow upon selecting the trajectory candidate as the target trajectory, and predetermines an acceleration ax(t) with which the vehicle 1 is to follow this path.

For planning the target trajectory, objects 2, 3 depicted in more detail in FIG. 6 of the planning horizon P are furthermore detected, and trajectory costs are respectively allocated to the trajectory candidates by means of a predetermined cost function. Here, the cost function comprises object costs depending on the detected objects 2, 3, wherein object costs of an object 2, 3 for a trajectory candidate increase with decreasing distance apart between the object 2, 3 and the trajectory candidate. The target trajectory is then selected from the number of trajectory candidates depending on the trajectory costs.

Here, a quality value Q is determined for each detected object 2, 3, which specifies a measure for a reliability of the detection of the object 2, 3, i.e., an existence probability of an object 2, 3 in the surroundings of the vehicle 1.

Furthermore, a minimally permissible acceleration aQ is determined for each object 2, 3 depending on its quality value Q, with which the vehicle 1 may be braked onto the corresponding object 2, 3.

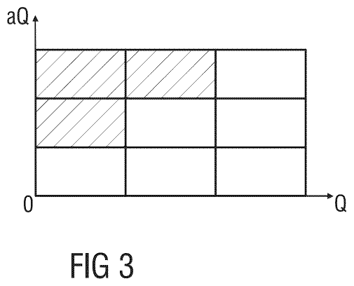

In FIG. 3, such a minimally permissible acceleration aQ is depicted depending on a reliability of a detection of an object 2, 3, i.e., depending on its quality value Q. When the vehicle is braking, the minimally permissible acceleration aQ has a negative value. Since a negative acceleration is a delay, the minimally permissible acceleration aQ simultaneously determines a maximally permissible delay.

The determination of the minimally permissible acceleration aQ with which an object 2, 3 may be braked onto is carried out taking the following condition into consideration:

$$min ( ax ( t ) ) \geq aQ . \qquad ( 4 )$$

Here, min (ax(t)) is the minimum acceleration in a trajectory T1 to Tn, wherein min (ax(t)) is also a negative value when braking.

It is thus checked with equation (4) as to whether the acceleration aQ remains in the permissible scope when braking, wherein the permissible scope is determined by the quality value Q of the corresponding object 2, 3.

Here, it is important that at least one predetermined trajectory T1 to Tn exists for each value of the minimally permissible acceleration aQ, at which the following applies:

$$min ( ax ( t ) ) = aQ . \qquad ( 5 )$$

In FIG. 3, both the minimally permissible acceleration aQ and the quality value are divided into a low, an average and a high region. Here, it is apparent that a braking with a maximum force is only permissible when the object 2, 3 has a high quality value Q (depicted by the non-hatched regions). For the objects 2, 3 with average and low quality value Q, such a braking is, in contrast, not permissible (depicted by the hatched regions).

In order to avoid problems when planning the target trajectory, when a collision of the vehicle 1 with an object 2, 3 with a low quality value Q can only be avoided with a target trajectory with a braking force greater than permitted, it is additionally provided that the trajectory candidates and the object costs determined for these are evaluated depending on the acceleration ax(t) predetermined by the respective trajectory candidate and depending on the minimally permissible acceleration aQ when braking onto the object 2, 3, and the selection of the target trajectory is additionally carried out taking into consideration the evaluation of the trajectory candidates and the object costs determined for these.

Here, the object costs of an object are evaluated for each trajectory of the trajectory set, wherein—as already stated—the object costs of an object 2, 3 for a trajectory candidate increase with decreasing longitudinal and transverse distance apart between the object 2, 3 and the trajectory candidate.

If several objects 2, 3 are present, then each of the objects 2, 3 could contribute to the object costs of a trajectory candidate. In such cases, it is checked which of the objects 2, 3 is the most relevant in terms of object costs, i.e., makes the highest contribution, and the determination of the object costs for the trajectory candidate is carried out exclusively on the basis of the most relevant object 2, 3. In other words: less relevant objects 2, 3 are not taken into account when determining the object costs.

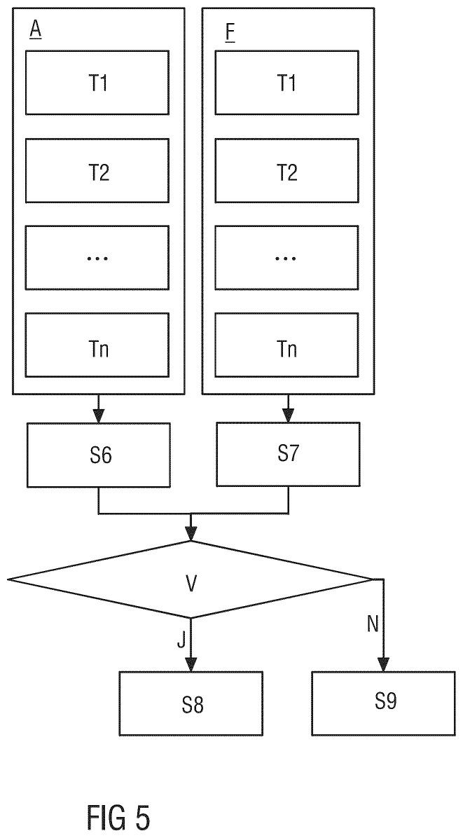

When evaluating the trajectory candidates and the object costs ascertained for these, a categorization is used in which a distinction is made between an unfiltered category A and a filtered category F, both depicted in FIG. 5. Here, all object costs and the corresponding trajectory candidates are allocated to the unfiltered category A. In contrast, only those object costs and the corresponding trajectory candidates for which the minimum of the acceleration min (ax(t)) predetermined by the respective trajectory candidate is greater than the minimally permissible acceleration aQ of the respective object 2, 3 are allocated to the filtered category F.

If an object 2, 3 may be braked with an acceleration of at most aQ=−5 m/s² because of its quality value and the corresponding trajectory T1 to Tn requires braking in which the acceleration min (ax(t)) drops to a value of −2 m/s², the condition min (ax(t)>aQ is fulfilled, i.e. 2 m/s²>−5 m/s². The corresponding trajectory T1 to Tn and the object costs are allocated to both category A and category F.

If an object 2, 3 may be braked with an acceleration of at most aQ=−5 m/s² because of its quality value Q and the corresponding trajectory T1 to Tn requires braking in which the acceleration min (ax(t)) drops to a value of −6 m/s², the condition min (ax(t))>aQ is not fulfilled. The corresponding trajectory T1 to Tn and the object costs are then allocated to the unfiltered category A but not the filtered category F.

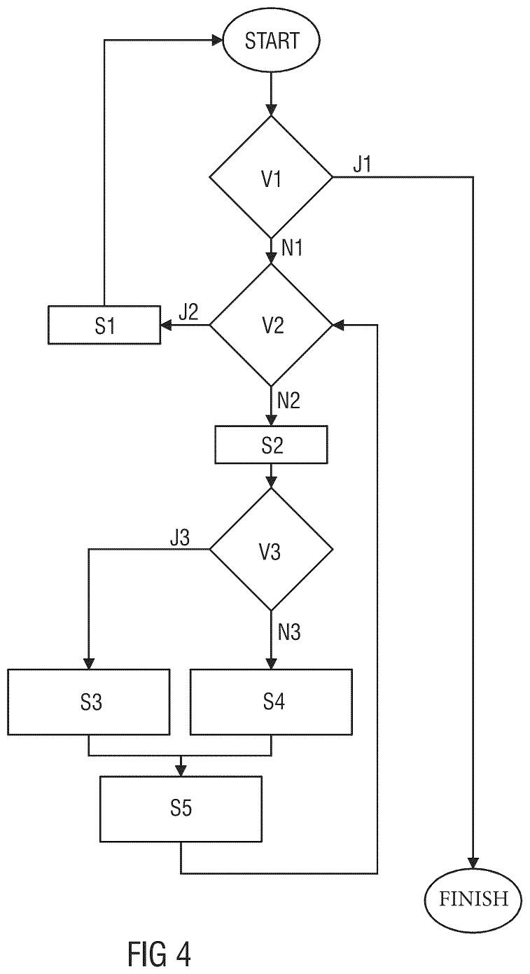

A possible exemplary embodiment of a process of a method for determining the object costs is depicted in FIG. 4.

Here, it is checked in a first branch V1 as to whether all trajectory candidates of a trajectory set have already been assessed. If this is the case, depicted by a yes-branch J1, the method is ended.

If this is not the case, depicted by a no-branch N1, it is checked in a second branch V2 as to whether all objects 2, 3 of a trajectory candidate have already been assessed. If this is the case, depicted by a yes-branch J2, the next trajectory candidate is selected in a method step S1 and the method is restarted for this.

If this is not the case, depicted by a no-branch N2, the determination of the object costs for the corresponding object 2, 3 of the corresponding trajectory candidate is carried out in a further method step S2.

Subsequently, in a third branch V3, the condition according to equation (4) is checked, and it is ascertained as to whether the minimum acceleration on the corresponding trajectory T1 to Tn is greater than the minimally permissible acceleration aQ.

If this is the case, depicted by a yes-branch J3, in a further method step S3, the object costs for the corresponding trajectory T1 to Tn are updated in the unfiltered category A and the filtered category F.

If this is not the case, depicted by a no-branch N3, in a further method step S4, the object costs for the corresponding trajectory T1 to Tn are only updated in the unfiltered category A.

After carrying out the method step S3 or the method step S4, in a further method step S5, the next object 2, 3 of the respective trajectory candidate is chosen, and the checking in the branch V2 is continued for this object 2, 3.

That is to say: for each trajectory T1 to Tn of the trajectory set and for each object 2, 3 from the number of objects 2, 3, the object costs are calculated for the respective trajectory T1 to Tn. When the condition min (ax(t))>aQ for the respective trajectory T1 to Tn and the respective object 2, 3 is fulfilled, the object costs are allocated to the two categories A, F, otherwise they are only allocated to the unfiltered category A.

If all object costs have been calculated for all possible combinations of trajectories T1 to Tn, the two best trajectories T1 to Tn from the two categories A, F are ascertained, and a target trajectory is selected from the two trajectories T1 to Tn.

FIG. 5 shows a possible exemplary embodiment of a process of a method for such an determining and selection.

Here, in a method step S6, the trajectory T1 to Tn with the lowest costs is determined from all trajectories T1 to Tn of the unfiltered category A.

In a further method step S7, the trajectory T1 to Tn with the lowest costs is determined from all trajectories T1 to Tn of the filtered category F.

It is subsequently checked in a branch V as to whether the minimum acceleration min (ax(t)) on a trajectory T1 to Tn of the unfiltered category A is greater than or equal to the minimum acceleration min (ax(t)) on a trajectory T1 to Tn of the filtered category F.

If this is the case, depicted by a yes-branch J, the corresponding trajectory T1 to Tn of the unfiltered category A is chosen as the target trajectory in a method step S8. If this is not the case, depicted by a no-branch N, the corresponding trajectory T1 to Tn of the unfiltered category A is chosen as the target trajectory in a method step S9.

FIG. 6 shows a top view of a traffic scenario with a vehicle 1 and several objects 2, 3, wherein the object 2 has a low quality value Q and the object 3 has a high quality value Q.

If, for example, the trajectory T5 is the cheapest trajectory candidate from the filtered category F, and the trajectory T5 purports that the acceleration ax(t) is to sink to a value of −5 m/s², for example, min (ax5 (t))=−5 m/s² applies.

In the unfiltered category A, the trajectory T1, for example, is the cheapest trajectory candidate. The trajectory T1 purports, for example, that the acceleration ax(t) is to sink to a value of −3 m/s², for example. Thus, min (ax1(t))=−3 m/s² applies.

Since with −3 m/s²≥−5 m/s², the condition min (ax1(t))≥ min (ax5 (t)) is fulfilled, the trajectory T1 is chosen as the target trajectory. If, in contrast, the condition were not to be met, the trajectory T5 would then be selected as the target trajectory.

If, for example, min (ax1(t))=−5 m/s², the two trajectories T1 and T5 thus brake with the same acceleration ax(t) on the object 3 moving in front. Here, the trajectory T1 also takes the object 2 with the low-quality value Q into consideration. The trajectory T5, on the other hand, does not. Since the condition min (ax1(t))≥ min (ax5 (t)) is also fulfilled here, the trajectory T1 is chosen as the target trajectory and the object 2 with the low-quality value Q is thus avoided.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-4. (canceled)

5. A method for planning a target trajectory for an automatically driving vehicle, the method comprising:
predetermining a number of trajectory candidates for a predetermined planning horizon, wherein each of the number of trajectory candidates predetermines a path the automatically driving vehicle is to follow upon selecting the trajectory candidate as the target trajectory, and an acceleration with which the vehicle is to follow on the path of the respective one of the number of trajectory candidates;
detecting objects within the predetermined planning horizon;
respectively allocating trajectory costs to each of the number trajectory candidates using a predetermined cost function, wherein the predetermined cost function comprises object costs depending on the detected objects, wherein object costs of an object for a trajectory candidate increase with decreasing distance between the object and the trajectory candidate;
selecting the target trajectory on the trajectory costs of the number of trajectory candidates,
wherein for each of the detected objects, a quality value is determined, the quality value specifying a measure for a degree of reliability of the detection of the respective one of the detected objects,
wherein for each of the detected objects, depending on the quality value for the respective one of the detected objects, a minimally permissible acceleration is determined with which the automatically driving vehicle may be braked onto the respective one of the detected objects,
wherein the trajectory candidates and the object costs determined for the trajectory candidates are evaluated depending on the acceleration predetermined by the respective trajectory candidate and depending on the minimally permissible acceleration when braking onto the object, and
wherein the selection of the target trajectory accounts for the evaluation of the trajectory costs and the object costs determined for the trajectory costs.

6. The method of claim 5, wherein a trajectory candidate of the number of trajectory candidates with a lowest trajectory costs is selected as the target trajectory from the number of trajectory candidates.

7. The method of claim 5, wherein
the evaluation of the trajectory candidates and the object costs determined for the trajectory candidates involves a categorization,
the categorization categorizes the number of trajectory candidates into an unfiltered category and a filtered category,
all object costs and the corresponding trajectory candidates are allocated to the unfiltered category, and
only those object costs and the corresponding trajectory candidates are allocated to the filtered category for which a minimum value of the acceleration predetermined by the respective trajectory candidate is greater than a minimally permissible acceleration of the respective detected object.

8. The method of claim 7, wherein, responsive to selecting the target trajectory,
a trajectory candidate of the number of trajectory candidates with the lowest trajectory costs is respectively selected from the unfiltered category and the filtered category,
the minimum of the acceleration predetermined by the respective trajectory candidate is respectively determined for the trajectory candidates with the lowest trajectory costs in the unfiltered category and the filtered category, and
a trajectory candidate of the trajectory candidates with the lowest trajectory costs in the unfiltered category and the filtered category with a greatest minimum is selected as the target trajectory.
